(19) United States
(12) Patent Application Publication
(10) Pub. No.: US 2026/0367354 A1
(43) Pub. Date: Nov. 19, 2026

(54) IMAGING APPARATUS WITH VENTING GROOVE AND SEALING MEMBER, AND ELECTRONIC DEVICE HAVING THE SAME

(71) Applicant: TRIPLE WIN TECHNOLOGY(SHENZHEN) CO.LTD., Shenzhen (CN)

(72) Inventor: JIN-LIANG SU, Foshan (CN)

(21) Appl. No.: 19/433,244

(22) Filed: Dec. 26, 2025

(30) Foreign Application Priority Data
May 14, 2025 (CN) 202510624912.4

(51) Int. Cl. G02B 7/02

(52) U.S. Cl. CPC G02B 7/02

(57) ABSTRACT

An imaging apparatus includes a circuit board, a bracket bonded to the circuit board and forming a first accommodating space, a lens, and a seal member. The bracket includes a bottom wall having an opening extending through the bottom wall, and a first surface facing away from the circuit board. A groove is formed on the first surface. The opening communicates with the first accommodating space and the groove, and the groove communicates with an exterior of the bracket. During heating/curing of the bracket and the circuit board, gas within the first accommodating space can be vented through the opening and the groove to the exterior, thereby reducing a risk that gas expansion separates a bonded interface between the bracket and the circuit board and improving performance and reliability. After venting, the seal member seals the groove to reduce ingress of contaminants and moisture. An electronic device including the imaging apparatus is also disclosed.

### CROSS-REFERENCE TO RELATED APPLICATION(S)

The present application claims the benefit and priority to Chinese Patent Application Serial No. 202510624912.4, filed on May 14, 2025, in China National Intellectual Property Administration, and the content of which is hereby fully incorporated by reference into the present application.

### FIELD

The subject matter relates to imaging devices, and particularly to an imaging apparatus having a venting structure and a sealing structure, and an electronic device having the imaging apparatus.

### BACKGROUND

Imaging apparatus is widely used in electronic devices such as mobile phones and tablet computers. During assembly, a bracket is typically bonded to a circuit board and then cured by heating. During the heating, gas in an internal accommodating space of the imaging apparatus may expand and tend to separate a bonding interface between the bracket and the circuit board, thereby degrading the performance and reliability of the imaging apparatus.

### BRIEF DESCRIPTION OF THE DRAWINGS

Implementations of the present technology will now be described, by way of example only, with reference to the attached figures, wherein:

FIG. 1 is a schematic view of an imaging apparatus according to an embodiment of the present application.

FIG. 2 is a schematic view of the imaging apparatus of FIG. 1, viewed from another angle.

FIG. 3 is an exploded view of the imaging apparatus of FIG. 1.

FIG. 4 is a sectional view of the imaging apparatus of FIG. 1.

FIG. 5 is a schematic view of a portion of the imaging apparatus of FIG. 1.

FIG. 6 is a sectional view of a portion of a bracket of the imaging apparatus of FIG. 1.

FIG. 7 is a schematic view of an electronic device including the imaging apparatus.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

For clarity, terms such as “first,” “second,” etc. are used for distinction and do not limit the scope. Unless otherwise stated, a first direction X, a second direction Y, and a third direction Z may be mutually perpendicular. The drawings are schematic and not necessarily to scale.

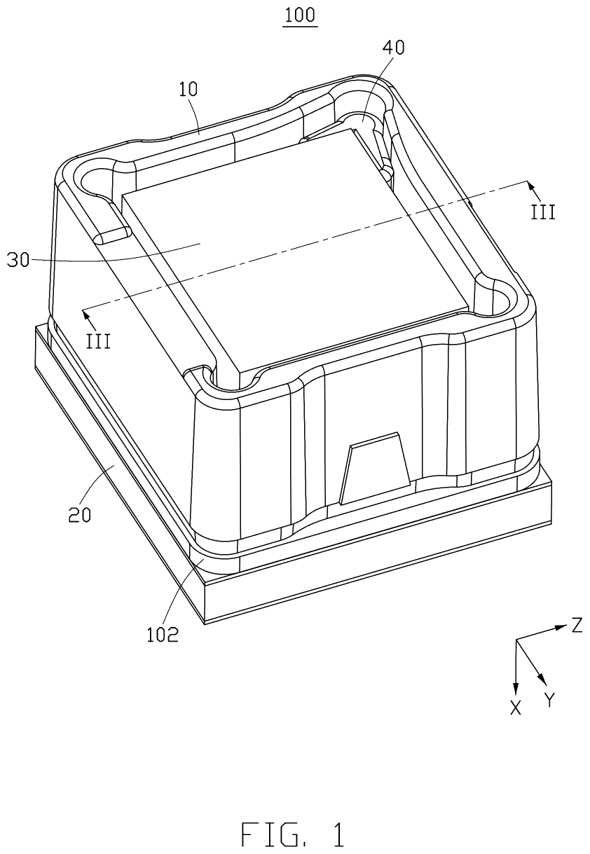

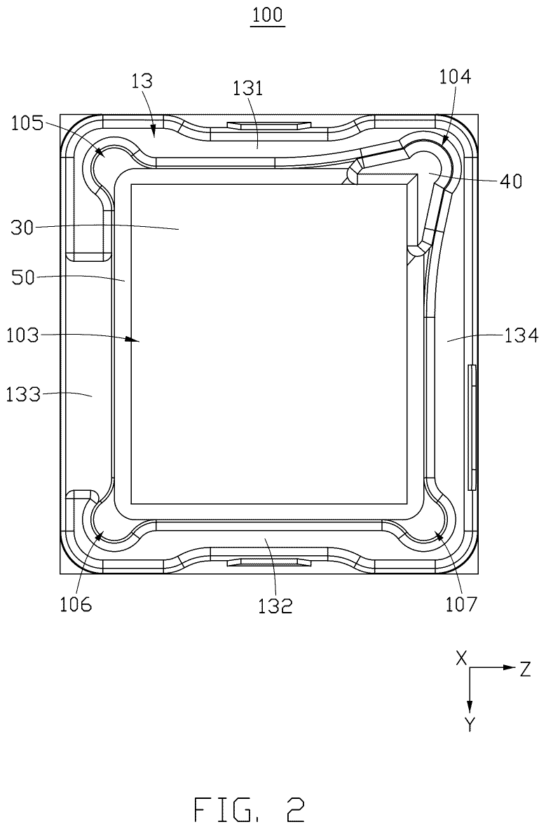

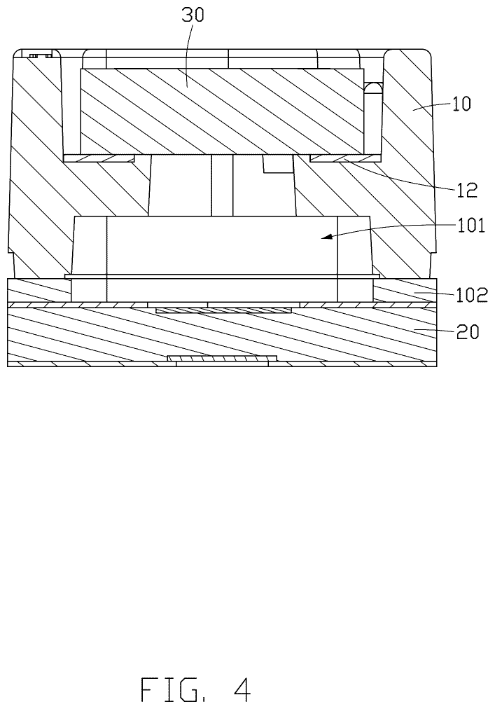

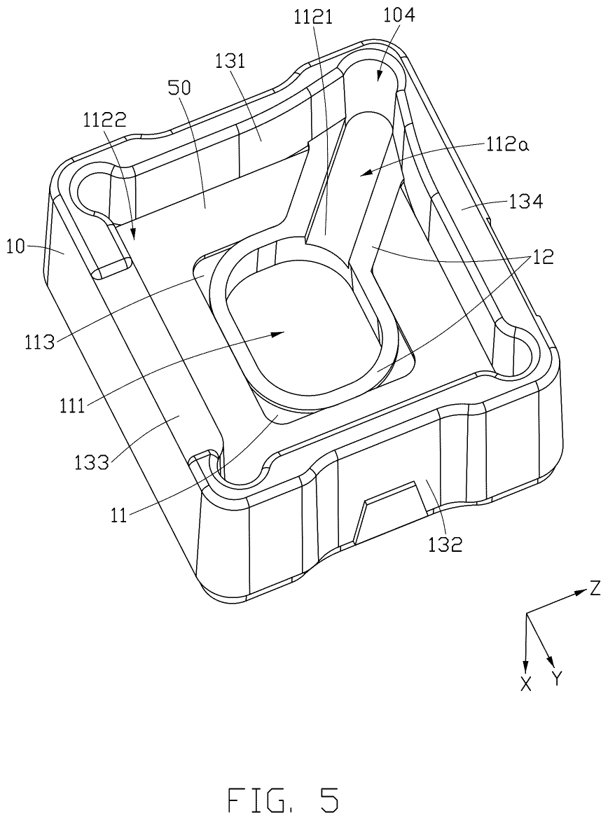

Referring to FIGS. 1-5, an imaging apparatus 100 is provided according to an embodiment of the present application. The imaging apparatus 100 includes a bracket 10 and a circuit board 20. The bracket 10 is bonded to the circuit board 20, and the bracket 10 and the circuit board 20 cooperatively define a first accommodating space 101.

The bracket 10 includes a bottom wall 11. The bottom wall 11 and the circuit board 20 are arranged along a first direction X. The bottom wall 11 defines an opening 111 extending through the bottom wall 11 along the first direction X. The bottom wall 11 includes a first surface 112 facing away from the circuit board 20. A groove 112a is formed on the first surface 112. The opening 111 communicates with the first accommodating space 101 and the groove 112a. The groove 112a communicates with an exterior of the bracket 10.

In some embodiments, the imaging apparatus 100 further includes a lens 30, and the lens 30 is coupled to the first surface 112.

In some embodiments, the imaging apparatus 100 further includes a seal member 40. The seal member 40 is configured to seal the groove 112a. In some embodiments, after a heating/baking process for the bracket 10 and the circuit board 20 is completed, the seal member 40 seals the groove 112a.

In this application, with the groove 112a formed on the first surface 112 of the bottom wall 11, when the bracket 10 and the circuit board 20 are cured by heating (e.g., baking), gas in the first accommodating space 101 flows from the opening 111 to the groove 112a and is exhausted to the exterior of the bracket 10 through the groove 112a. As such, a risk that the expanding gas separates the bonding interface between the bracket 10 and the circuit board 20 can be reduced, thereby reducing negative influence on performance and reliability. After venting, by sealing the groove 112a using the seal member 40, ingress of external contaminants and moisture into the first accommodating space 101 can be reduced.

In some embodiments, the groove 112a extends in a straight line to shorten a venting path and improve venting efficiency.

In some embodiments, the imaging apparatus 100 further includes an adhesive 102. The bracket 10 is bonded to the circuit board 20 by the adhesive 102. The adhesive 102 may include at least one of a UV-curable adhesive, a modified epoxy resin, and a silicone adhesive.

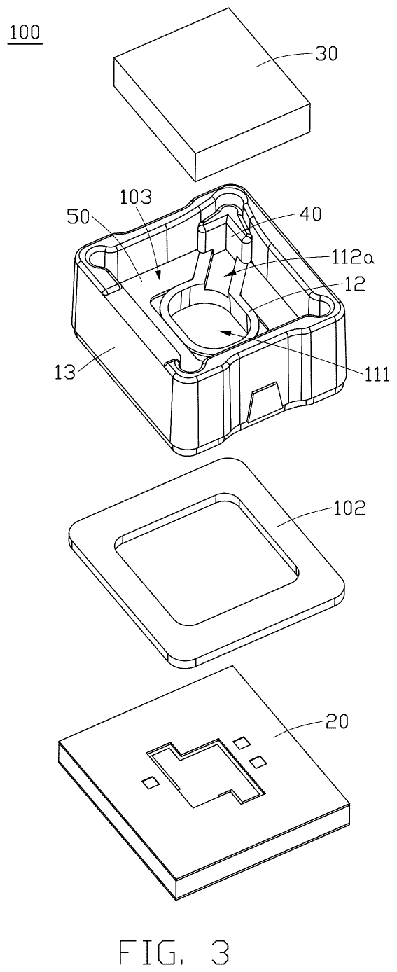

Referring to FIGS. 3-5, in some embodiments, the imaging apparatus 100 further includes an adhesive member 50 for bonding the lens 30 to the first surface 112. The adhesive member 50 is spaced apart from the opening 111 to reduce a likelihood that the adhesive member 50 overflows into the opening 111 and affects imaging quality. In some embodiments, the adhesive member 50 is further spaced apart from the groove 112a to reduce a likelihood that overflow blocks the groove 112a and affects venting.

In some embodiments, the bracket 10 further includes a protrusion 12 on the first surface 112. The protrusion 12 supports a portion of the lens 30, and another portion of the lens 30 is bonded to the first surface 112 by the adhesive member 50. By supporting the lens 30 with the protrusion 12, a thickness of the adhesive member 50 can be more uniform and an assembly tilt tolerance of the lens 30 can be reduced, thereby reducing adverse impact on imaging quality.

In some embodiments, the protrusion 12 divides the first surface 112 into a first region 1121 and a second region 1122. The opening 111 and the groove 112a are located in the first region 1121, and the adhesive member 50 is located in the second region 1122. In some embodiments, along the first direction X, a height of the adhesive member 50 does not exceed the protrusion 12, thereby reducing the likelihood of overflow of the adhesive member 50 into the opening 111 and/or the groove 112a.

In some embodiments, the bracket 10 includes a plurality of sidewalls 13 connected to the bottom wall 11 to define a second accommodating space 103, and the lens 30 is disposed in the second accommodating space 103.

In some embodiments, the bracket 10 includes a first recess 104 at a junction of two adjacent sidewalls 13. The lens 30 is spaced apart from the first recess 104, and the groove 112a communicates with the first recess 104.

In some embodiments, when the lens 30 is coupled to the protrusion 12, the lens 30 is located above the groove 112a and closes a portion of the groove 112a to form a vent passage. A portion of the groove 112a extends beyond an edge of the lens 30 and communicates with the first recess 104. An inlet of the vent passage communicates with the opening 111, and an outlet of the vent passage communicates with the first recess 104.

In some embodiments, the seal member 40 is injected into the groove 112a through the first recess 104 and seals the groove 112a. In some embodiments, the seal member 40 fills a portion of the groove 112a that extends beyond the lens 30 to seal the outlet of the vent passage. In some embodiments, the seal member 40 further bonds a side surface of the lens 30 to the two adjacent sidewalls 13 and fills the first recess 104, thereby improving sealing performance. In some embodiments, the seal member 40 is formed by curing a sealing adhesive injected into the groove 112a.

In some embodiments, the sidewalls 13 include four sidewalls, including a first sidewall 131, a second sidewall 132, a third sidewall 133, and a fourth sidewall 134. The first sidewall 131 and the second sidewall 132 are arranged along the second direction Y. The third sidewall 133 and the fourth sidewall 134 are arranged along the third direction Z. Junctions of the sidewalls form a second recess 105, a third recess 106, a fourth recess 107, and the first recess 104, and a size of the first recess 104 is greater than a size of each of the second recess 105, the third recess 106, and the fourth recess 107, so as to facilitate injection of the seal member 40 and improve venting efficiency.

In some embodiments, thickness of the first sidewall 131 decreases gradually from a middle position toward a junction between the first sidewall 131 and the third sidewall 133, and thickness of the fourth sidewall 134 decreases gradually from a middle position toward a junction between the first sidewall 131 and the third sidewall 133, thereby forming the first recess 104 and making the first recess 104 larger.

In some embodiments, by arranging the groove 112a in the bottom wall 11, thicknesses of the sidewalls 13 can be reduced to facilitate miniaturization. In some embodiments, a maximum thickness of each sidewall 13 is not greater than 0.26 mm.

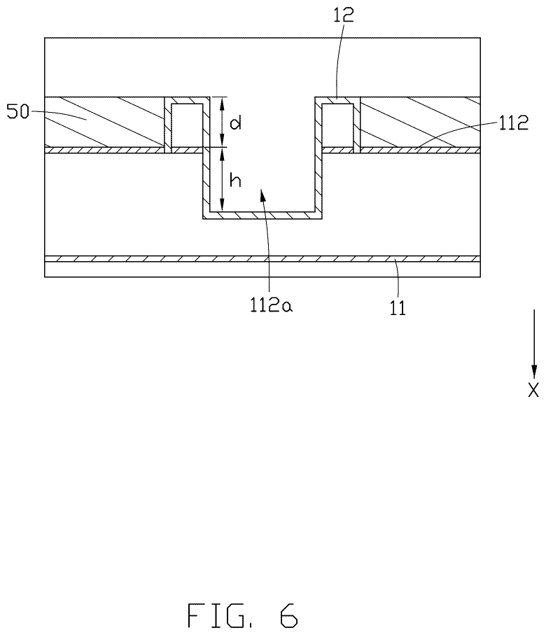

Referring to FIG. 6, in some embodiments, along the first direction X, a depth h of the groove 112a satisfies: 30 μm≤h≤100 μm, which facilitates venting while reducing impact on structural strength of the bottom wall 11. In some embodiments, along the first direction X, a height d of the protrusion 12 satisfies 30 μm≤d≤120 μm, which helps to block the adhesive member 50 from entering the opening 111 and/or the groove 112a.

In some embodiments, the imaging apparatus 100 further includes an image sensor (not shown) coupled to the circuit board 20 and disposed below the lens 30. In some embodiments, the lens 30 includes a metasurface lens. In some embodiments, the imaging apparatus 100 further includes a flexible circuit board electrically connected to the circuit board 20 to electrically connect the imaging apparatus 100 to an external electronic device.

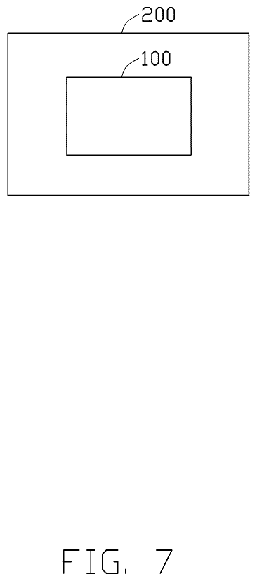

Referring to FIG. 7, an electronic device 200 is further provided. The electronic device 200 includes the imaging apparatus 100 described above. The electronic device 200 may be a mobile phone, a tablet computer, an electronic reader, a laptop computer, a wearable device, or the like.

The embodiments shown and described above are only examples. Many details are often found in the art. Therefore, such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. An imaging apparatus, comprising:
a circuit board;
a bracket connected to the circuit board and defining a first accommodating space, the bracket comprising a bottom wall, wherein the bottom wall and the circuit board are arranged along a first direction, the bottom wall defines an opening extending through the bottom wall along the first direction, the bottom wall comprises a first surface facing away from the circuit board, the first surface defines a groove, the opening communicates with the first accommodating space and the groove, and the groove communicates with an exterior of the bracket;
a lens coupled to the first surface; and
a seal member configured to seal the groove.

2. The imaging apparatus of claim 1, further comprising an adhesive member bonded between the lens and the first surface, wherein the adhesive member is spaced apart from the opening and the groove.

3. The imaging apparatus of claim 2, wherein the bracket further comprises a protrusion on the first surface, and the protrusion supports the lens.

4. The imaging apparatus of claim 3, wherein the protrusion divides the first surface into a first region and a second region, the opening and the groove are located in the first region, and the adhesive member is located in the second region.

5. The imaging apparatus of claim 3, wherein along the first direction, a height of the adhesive member is less or equal to a height of the protrusion.

6. The imaging apparatus of claim 1, wherein the bracket further comprises a plurality of sidewalls, the plurality of sidewalls is connected to the bottom wall to define a second accommodating space, and the lens is disposed in the second accommodating space.

7. The imaging apparatus of claim 6, wherein the bracket further comprises a first recess located at a junction of two of the plurality of sidewalls, the lens is spaced apart from the first recess, and the groove communicates with the first recess.

8. The imaging apparatus of claim 7, wherein the plurality of sidewalls comprises four sidewalls, junctions of the four sidewalls form a second recess, a third recess, a fourth recess, and the first recess, and a size of the first recess is greater than a size of each of the second recess, the third recess, and the fourth recess.

9. The imaging apparatus of claim 3, wherein along the first direction, a depth of the groove is in a range from 30 μm to 100 μm, and a height of the protrusion is in a range from 30 μm to 120 μm.

10. The imaging apparatus of claim 1, wherein the groove extends along a straight line.

11. The imaging apparatus of claim 1, wherein the bracket is bonded to the circuit board by an adhesive.

12. The imaging apparatus of claim 11, wherein the adhesive comprises at least one of a UV-curable adhesive, a modified epoxy resin, and a silicone adhesive.

13. An electronic device, comprising an imaging apparatus, the imaging apparatus comprising:
a circuit board;
a bracket connected to the circuit board;
a lens connected to the bracket, and a seal member;
wherein the bracket forms a first accommodating space, the bracket comprises a bottom wall, the bottom wall and the circuit board are arranged along a first direction, the bottom wall defines an opening extending through the bottom wall along the first direction, the bottom wall comprises a first surface facing away from the circuit board, the first surface defines a groove, the opening communicates with the first accommodating space and the groove, and the groove communicates with an exterior of the bracket, the lens is coupled to the first surface, the seal member is configured to seal the groove.

14. The electronic device of claim 13 further comprising an adhesive member, wherein the adhesive member is bonded between the lens and the first surface, the adhesive member is spaced apart from the opening and the groove.

15. The electronic device of claim 14, wherein the bracket further comprises a protrusion on the first surface, and the protrusion supports the lens.

16. The electronic device of claim 15, wherein the protrusion divides the first surface into a first region and a second region, the opening and the groove are located in the first region, and the adhesive member is located in the second region.

17. The electronic device of claim 13, wherein the bracket further comprises a plurality of sidewalls, the plurality of sidewalls is connected to the bottom wall to define a second accommodating space, the lens is disposed in the second accommodating space, the bracket further comprises a first recess located at a junction of two adjacent sidewalls, the lens is spaced apart from the first recess, and the groove communicates with the first recess.

18. The electronic device of claim 15, wherein, along the first direction, a height of the adhesive member is less or equal to a height of the protrusion.

19. The electronic device of claim 14, wherein the plurality of sidewalls comprise four sidewalls, junctions of the four sidewalls form a second recess, a third recess, a fourth recess, and the first recess, and a size of the first recess is greater than a size of each of the second recess, the third recess, and the fourth recess.

20. The electronic device of claim 10, wherein along the first direction, a depth of the groove is in a range from 30 μm to 100 μm, and a height of the protrusion is in a range from 30 μm to 120 μm.
